(19) United States
(12) Patent Application Publication
(10) Pub. No.: US 2026/0141558 A1
(43) Pub. Date: May 21, 2026

(54) MEASUREMENT DEVICE, MEASUREMENT METHOD, AND RECORDING MEDIUM

(71) Applicant: Evident Inspection Technologies Japan Corporation, Tatsuno-machi (JP)

(72) Inventors: Shota TAKAHASHI, Kamiina-gun (JP); Naofumi ENDO, Kamiina-gun (JP); Tsuyoshi FURUHATA, Kamiina-gun (JP)

(73) Assignee: Evident Inspection Technologies Japan Corporation, Tatsuno-machi (JP)

(21) Appl. No.: 19/372,468

(22) Filed: Oct. 29, 2025

(30) Foreign Application Priority Data
Nov. 15, 2024 (JP) 2024-199740

(51) Int. Cl. G06T 7/73; G01N 21/954; G06T 7/00; G06T 7/50; G06T 11/60

(52) U.S. Cl. CPC G06T 7/74; G01N 21/954; G06T 7/001; G06T 7/50; G06T 11/60; G06T 2200/04; G06T 2207/10068; G06T 2207/30108

(57) ABSTRACT

A measurement device includes a processor. The processor acquires three-dimensional data including three-dimensional coordinates of two or more points on a subject and sets a measurement reference. The processor detects one or more feature regions on the subject and outputs an image of a three-dimensional shape of the subject to a display. The processor selects at least one feature region of the one or more feature regions as a measurement target region. The processor generates distance information indicating a distance between the measurement reference and the measurement point, superimposes a measurement result generated based on the distance information on an image of the measurement target region, and outputs the image on which the measurement result is superimposed to the display.

### BACKGROUND OF THE INVENTION

### Field of the Invention

The present invention relates to a measurement device, a measurement method, and a recording medium.

Priority is claimed on Japanese Patent Application No. 2024-199740, filed Nov. 15, 2024, the content of which is incorporated herein by reference.

### Description of Related Art

An industrial endoscope device has been used for inspection (endoscopic inspection) for abnormality, corrosion, and the like inside boilers, pipes, aircraft engines, heat exchangers, and the like. A device disclosed in Japanese U.S. Pat. No. 6,030,837 includes a long and thin probe including an insertion tube which can be inserted into an observation target and generates an image based on an optical image acquired via the probe. That device determines three-dimensional (3D) coordinates of points in the observation target using an image of the observation target and determines a reference plane using 3D coordinates of three or more points. That device calculates the distance between the reference plane and each point and displays a color map of the point that is colored in accordance with the distance.

### SUMMARY OF THE INVENTION

According to an aspect of the present invention, a measurement device includes a processor. The processor acquires three-dimensional data including three-dimensional coordinates of two or more points on a subject which are calculated based on an endoscopic image of the subject acquired by an endoscope. The processor sets a measurement reference indicating a reference position for measurement and detects one or more feature regions on the subject based on the three-dimensional data or the endoscopic image. A three-dimensional shape of the subject has a common feature in each of the one or more feature regions. The processor selects at least one feature region of the one or more feature regions as a measurement target region. The processor sets one or more points included in the measurement target region and included in the two or more points as a measurement point. The processor generates distance information indicating a distance between the measurement reference and the measurement point. The processor superimposes a measurement result generated based on the distance information on an image of the measurement target region. The processor outputs the image on which the measurement result is superimposed to a display.

According to an aspect of the present invention, the processor may superimpose a graphic having a display state that is set based on the distance information as the measurement result on the image of the measurement target region.

According to an aspect of the present invention, the processor may select at least one measurement point of two or more measurement points based on a distance indicated by the distance information of each of the two or more measurement points included in the measurement target region. The processor may superimpose information on the at least one measurement point as the measurement result on the image of the measurement target region.

According to an aspect of the present invention, the processor may select a measurement point for which the distance is largest or smallest as the at least one measurement point.

According to an aspect of the present invention, the processor may calculate a reference value based on the distance and may select the at least one measurement point based on a result of comparing the distance with the reference value.

According to an aspect of the present invention, the processor may set all points included in the measurement target region and included in the two or more points as the measurement point.

According to an aspect of the present invention, the processor may detect the one or more feature regions based on a shape feature of the two or more points included in the three-dimensional data.

According to an aspect of the present invention, the processor may detect the one or more feature regions based on an image feature of the endoscopic image.

According to an aspect of the present invention, when only one feature region on the subject is detected, the processor may select the one feature region as the measurement target region.

According to an aspect of the present invention, when two or more feature regions on the subject are detected, the processor may select at least one feature region of the two or more feature regions as the measurement target region.

According to an aspect of the present invention, the processor may select a feature region in which a distance between each of the two or more feature regions and a position of a distal end of the endoscope is smallest as the measurement target region.

According to an aspect of the present invention, the processor may select the at least one feature region as the measurement target region based on a shape feature of the two or more feature regions.

According to an aspect of the present invention, the processor may select the at least one feature region as the measurement target region based on information input to an input device.

According to an aspect of the present invention, the processor may set a point at a position of a distal end of the endoscope as the measurement reference.

According to an aspect of the present invention, the processor may set a point at a position of a distal end of the endoscope as a first measurement reference. The processor may set a second measurement reference including one or more points of the two or more points. The processor may generate first distance information indicating a distance between the first measurement reference and the measurement point. The processor may generate second distance information indicating a distance between the second measurement reference and the measurement point. The processor may superimpose a first measurement result generated based on the first distance information on the image of the measurement target region. The processor may superimpose a second measurement result generated based on the second distance information on the image of the measurement target region. The processor may output the image on which the first measurement result is superimposed and the image on which the second measurement result is superimposed to the display.

According to an aspect of the present invention, the processor may output one of the image on which the first measurement result is superimposed and the image on which the second measurement result is superimposed to the display. Displaying the image on which the first measurement result is superimposed and displaying the image on which the second measurement result is superimposed may be switchable.

According to an aspect of the present invention, the processor may calculate a distance between the measurement reference and each of the two or more points. The processor may select at least one point of the two or more points based on the distance between the measurement reference and each of the two or more points. The processor may output information of a feature region which is included in the one or more feature regions and which includes the at least one point to the display.

According to an aspect of the present invention, a measurement method includes: acquiring three-dimensional data including three-dimensional coordinates of two or more points on a subject which are calculated based on an endoscopic image of the subject acquired by an endoscope; setting a measurement reference indicating a reference position for measurement; and detecting one or more feature regions on the subject based on the three-dimensional data or the endoscopic image. A three-dimensional shape of the subject has a common feature in each of the one or more feature regions. The measurement method further includes: selecting at least one feature region of the one or more feature regions as a measurement target region; setting one or more points included in the measurement target region and included in the two or more points as a measurement point; generating distance information indicating a distance between the measurement reference and the measurement point; superimposing a measurement result generated based on the distance information on an image of the measurement target region; and outputting the image on which the measurement result is superimposed to a display.

According to an aspect of the present invention, a non-transitory computer-readable recording medium stores a program causing a computer to execute: acquiring three-dimensional data including three-dimensional coordinates of two or more points on a subject which are calculated based on an endoscopic image of the subject acquired by an endoscope; setting a measurement reference indicating a reference position for measurement; and detecting one or more feature regions on the subject based on the three-dimensional data or the endoscopic image. A three-dimensional shape of the subject has a common feature in each of the one or more feature regions. The program causes the computer to further execute: selecting at least one feature region of the one or more feature regions as a measurement target region; setting one or more points included in the measurement target region and included in the two or more points as a measurement point; generating distance information indicating a distance between the measurement reference and the measurement point; generating a graphic superimposed on an image of the measurement target region based on a measurement result generated based on the distance information; and outputting the image of the measurement target region and the graphic.

### BRIEF DESCRIPTION OF THE DRAWINGS

FIG. 1 is a block diagram showing an example of the configuration of an endoscope system according to a first embodiment of the present invention.

FIG. 2 is a flowchart showing an example of a procedure of a measurement process in the first embodiment of the present invention.

FIG. 3 is a diagram showing an example of an image displayed on a display included in the endoscope system according to the first embodiment of the present invention.

FIG. 4 is a diagram showing an example of an image displayed on the display included in the endoscope system according to the first embodiment of the present invention.

FIG. 5 is a diagram showing an example of an image displayed on the display included in the endoscope system according to the first embodiment of the present invention.

FIG. 6 is a diagram showing an example of an image displayed on the display included in the endoscope system according to the first embodiment of the present invention.

FIG. 7 is a block diagram showing an example of the configuration of an endoscope system according to a second modified example of the first embodiment of the present invention.

FIG. 8 is a block diagram showing an example of the configuration of an endoscope system according to a third modified example of the first embodiment of the present invention.

FIG. 9 is a flowchart showing an example of a procedure of a measurement process in a second embodiment of the present invention.

FIG. 10 is a diagram showing an example of an image displayed on a display of an endoscope system according to the second embodiment of the present invention.

FIG. 11 is a flowchart showing an example of a procedure of a measurement process in a third embodiment of the present invention.

FIG. 12 is a diagram showing an example of an image displayed on a display of an endoscope system according to the third embodiment of the present invention.

FIG. 13 is a flowchart showing an example of a procedure of a measurement process in a modified example of the third embodiment of the present invention.

FIG. 14 is a diagram showing an example of an image displayed on a display of an endoscope system according to the modified example of the third embodiment of the present invention.

FIG. 15 is a diagram showing an example of an image displayed on the display of the endoscope system according to the modified example of the third embodiment of the present invention.

FIG. 16 is a diagram showing an example of an image displayed on the display of the endoscope system according to the modified example of the third embodiment of the present invention.

FIG. 17 is a flowchart showing an example of a procedure of a measurement process in a fourth embodiment of the present invention.

FIG. 18 is a diagram showing an example of an image displayed on a display of an endoscope system according to the fourth embodiment of the present invention.

FIG. 19 is a diagram showing an example of an image displayed on the display included in the endoscope system according to the fourth embodiment of the present invention.

### DETAILED DESCRIPTION OF THE INVENTION

Hereinafter, an embodiment of the present invention will be described with reference to the drawings. In the following description, an endoscope system will be described as an example of a measurement device.

### First Embodiment

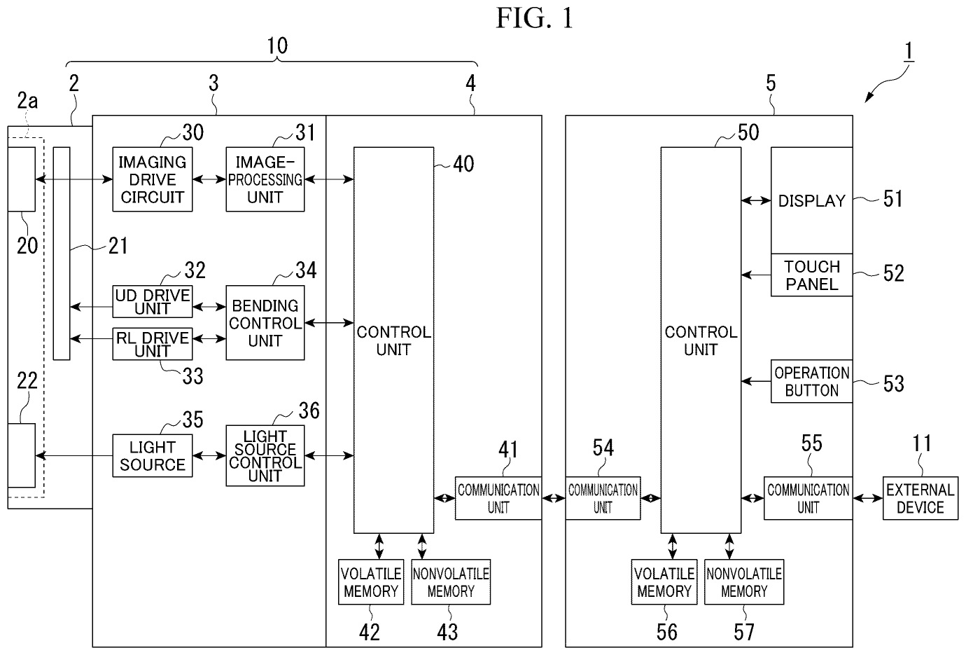

FIG. 1 shows an example of the configuration of an endoscope system 1 according to a first embodiment of the present invention. The endoscope system 1 shown in FIG. 1 includes an insertion unit 2, a scope unit 3, a base unit 4, and a main unit 5. The insertion unit 2, the scope unit 3, and the base unit 4 constitute an endoscope device 10. The main unit 5 is an operation device.

The insertion unit 2 is inserted into a subject which is an observation target. The subject is an industrial product. The insertion unit 2 has a thin and long tube shape and is bendable. A user performs an insertion operation and inserts the insertion unit 2 into the subject. An optical adapter is attached to the distal end of the insertion unit 2. The insertion unit 2 acquires an optical image in the subject. The insertion unit 2 includes an imaging unit 20, a bending portion 21, and an illumination window 22.

The imaging unit 20 is disposed in a distal end portion 2a including the distal end of the insertion unit 2. The imaging unit 20 is an image sensor such as a charge-coupled device (CCD) image sensor or a complementary metal-oxide-semiconductor (CMOS) image sensor. The imaging unit 20 generates an image based on an optical image acquired by the insertion unit 2. The image generated by the imaging unit 20 is output to the scope unit 3.

The bending portion 21 bends the insertion unit 2 upward (U), downward (D), leftward (L), or rightward (R). Alternatively, the bending portion 21 bends the insertion unit 2 up-leftward (UL), up-rightward (UR), down-leftward (DL), or down-rightward (DR).

Illumination light is generated by a light source 35 disposed in the scope unit 3 and is output to the distal end portion 2a via a light guide (not shown) disposed in the insertion unit 2. The illumination light is emitted to the inside of the subject via the illumination window 22.

The scope unit 3 includes an imaging drive circuit 30, an image-processing unit 31, a UD drive unit 32, an RL drive unit 33, a bending control unit 34, a light source 35, and a light source control unit 36. The base unit 4 includes a control unit 40, a communication unit 41, a volatile memory 42, and a nonvolatile memory 43.

The imaging drive circuit 30 controls the imaging unit 20 and outputs an image output from the imaging unit 20 to the image-processing unit 31. The image-processing unit 31 executes image processing such as noise reduction on the image output from the imaging unit 20 and outputs the image to the control unit 40.

The UD drive unit 32 is connected to a UD bending wire used for bending the bending portion 21 in the U direction or the D direction. The UD drive unit 32 includes a motor and bends the bending portion 21 in the U direction or the D direction by pulling the UD bending wire. The RL drive unit 33 is connected to an RL bending wire used for bending the bending portion 21 in the R direction or the L direction. The RL drive unit 33 includes a motor and bends the bending portion 21 in the R direction or the L direction by pulling the RL bending wire. The bending control unit 34 controls the UD drive unit 32 and the RL drive unit 33.

The UD drive unit 32 and the RL drive unit 33 can operate simultaneously. For example, the UD drive unit 32 and the RL drive unit 33 can bend the bending portion 21 in the UL direction.

The light source 35 is a light-emitting diode (LED) or the like and generates illumination light. The illumination light is output from the light source 35 to a light guide (not shown). The light source control unit 36 controls the light source 35.

The control unit 40 controls each unit of the scope unit 3 and the base unit 4. At least one of the control unit 40, the image-processing unit 31, the bending control unit 34, and the light source control unit 36 may be constituted by at least one of a processor and a logic circuit. For example, the processor is at least one of a central processing unit (CPU), a digital signal processor (DSP), and a graphics-processing unit (GPU). For example, the logic circuit is at least one of an application-specific integrated circuit (ASIC) and a field-programmable gate array (FPGA). At least one of the control unit 40, the image-processing unit 31, the bending control unit 34, and the light source control unit 36 may include one or more processors. At least one of the control unit 40, the image-processing unit 31, the bending control unit 34, and the light source control unit 36 may include one or more logic circuits.

A computer of the endoscope system 1 may read a program and execute the read program. The program includes instructions for prescribing the operation of at least one of the control unit 40, the image-processing unit 31, the bending control unit 34, and the light source control unit 36. That is, the function of at least one of the control unit 40, the image-processing unit 31, the bending control unit 34, and the light source control unit 36 may be realized by software.

The program may be provided, for example, using a “computer-readable recording medium” such as a flash memory. The program may be transmitted from a computer storing the program to the endoscope system 1 via a transmission medium or using carrier waves in the transmission medium. The “transmission medium” for transmitting a program is a medium having a function of transmitting information. The medium having a function of transmitting information includes a network (a communication network) such as the Internet and a communication circuit line (a communication line) such as a telephone line. The program may realize some of the aforementioned functions. The program may be a differential file (a differential program). The aforementioned functions may be realized in combination of the differential program with a program recorded in advance in the computer.

The communication unit 41 includes a communication circuit and executes wired communication or wireless communication for bending control with the main unit 5. The communication unit 41 transmits an image generated by the imaging unit 20 to the main unit 5. The volatile memory 42 is a random access memory (RAM), a dynamic RAM (DRAM), or the like. The volatile memory 42 stores various kinds of information processed by the control unit 40. The nonvolatile memory 43 is a static RAM (SRAM), an erasable programmable read-only memory (EPROM), an electrically erasable programmable read-only memory (EEPROM), or a flash memory. The nonvolatile memory 43 may be attachable to and detachable from the base unit 4. The nonvolatile memory 43 stores an image generated by the imaging unit 20 and various kinds of information processed by the control unit 40.

The main unit 5 includes a control unit 50, a display 51, a touch panel 52, an operation button 53, a communication unit 54, a communication unit 55, a volatile memory 56, and a nonvolatile memory 57. The main unit 5 may be an information terminal such as a smartphone or a tablet terminal.

The control unit 50 controls each unit of the main unit 5. The control unit 50 may be constituted by at least one of a processor and a logic circuit. The control unit 50 may include one or more processors or one or more logic circuits. A computer of the endoscope system 1 may read a program and execute the read program. The program includes instructions for prescribing the operation of the control unit 50. That is, the function of the control unit 50 may be realized by software. The program for realizing the function of the control unit 50 may be realized in the same way as the program for realizing the functions of the control unit 40 and the like.

The display 51 is a monitor such as a liquid crystal display (LCD). The display 51 displays an image generated by the imaging unit 20. The touch panel 52 receives an operation for inputting information required for control of the endoscope system 1. The touch panel 52 is disposed on a screen of the display 51. A user can input an instruction required for changing settings of the endoscope system 1, an instruction required for operating the endoscope system 1, and the like to the endoscope system 1 by operating the touch panel 52.

The operation button 53 receives various instructions from a user. The user can input an instruction related to power supply or illumination to the endoscope system 1 by pressing the operation button 53. The communication unit 54 executes wired communication or wireless communication for bending control with the base unit 4. The communication unit 54 receives an image generated by the imaging unit 20 from the base unit 4. The communication unit 55 executes wired communication or wireless communication with an external device 11. The external device 11 is a remote controller, a keyboard, a mouse, or the like.

The volatile memory 56 is the same memory as the volatile memory 42 and stores various kinds of information processed by the control unit 50. The nonvolatile memory 57 is the same memory as the nonvolatile memory 43 and stores an image generated by the imaging unit 20 and various kinds of information processed by the control unit 50. The nonvolatile memory 57 may be attachable to and detachable from the main unit 5.

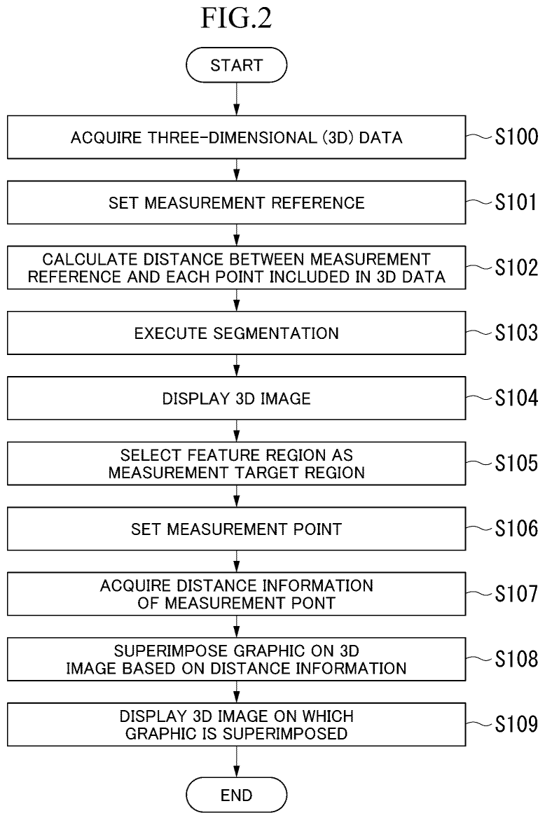

FIG. 2 shows an example of a procedure of a measurement process executed by the endoscope system 1. The operations of the endoscope system 1 will be described with reference to FIG. 2.

The control unit 50 acquires 3D data (Step S100).

The control unit 50 executes the following process in Step S100. First to third examples will be described below.

First, the first example will be described. The optical adapter in the first example is a stereo optical adapter having two fields of view. The optical adapter includes a first optical system and a second optical system corresponding to two fields of view. The first optical system and the second optical system form two optical images of a subject on the imaging unit 20. The imaging unit 20 generates a stereoscopic image corresponding to the first optical image and the second optical image. The stereoscopic image includes a pair of two images (a first image and a second image). That is, the stereoscopic image includes an image of the subject when seen from a first field of view and an image of the subject when seen from a second field of view. The control unit 50 calculates 3D coordinates of two or more points on the subject using one or more stereoscopic images generated by the imaging unit 20 and generates 3D data including the 3D coordinates.

The second example will be described. The optical adapter in the second example is a monocular optical adapter having one field of view. The optical adapter in the first example forms two optical images of the subjects, and the optical adapter in the second example forms a single optical image of the subject. The imaging unit 20 generates an image corresponding to the optical image formed by the optical adapter. The imaging unit 20 executes imaging at two or more different viewpoints and generates two or more images. The control unit 50 calculates 3D coordinates of two or more points on the subject using the two or more images generated by the imaging unit 20 and generates 3D data including the 3D coordinates.

The third example will be described. The 3D data generated in the first example or the second example is stored in advance in the nonvolatile memory 57. The control unit 50 acquires the 3D data from the nonvolatile memory 57.

The 3D coordinates included in the 3D data are defined in a 3D space corresponding to a real space. In the following description, points having 3D coordinates included in the 3D data are referred to as points included in the 3D data. The control unit 50 may generate 3D data including 3D coordinates of three or more points.

After Step S100, the control unit 50 sets a measurement reference in a space including the two or more points included in the 3D data. For example, information indicating the measurement reference to be used is stored in the nonvolatile memory 57, and the control unit 50 sets the measurement reference based on the information (Step S101). The measurement reference indicates a reference position for calculating a 3D distance that will be described later. In the following example, the measurement reference indicates a position of a distal end of an endoscope. The distal end of the endoscope corresponds to the distal end of the insertion unit 2.

After Step S101, the control unit 50 calculates the 3D distance between the measurement reference and each of the two or more points included in the 3D data. That is, the control unit 50 calculates the 3D distance between a point at the distal end of the endoscope and each of the points included in the 3D data. The control unit 50 generates distance information indicating the calculated 3D distance (Step S102). The distance information is stored in the volatile memory 56.

After Step S102, the control unit 50 executes segmentation. The control unit 50 detects one or more segments (feature regions) on the subject using the 3D data in the segmentation. The control unit 50 may detect one or more segments using one or more two-dimensional (2D) images used to generate the 3D data. The one or more 2D images are one or more stereoscopic images acquired using a stereoscopic optical adapter or are two or more images acquired using a monocular optical adapter (Step S103). Information of the segments is stored in the volatile memory 56.

Details of Step S103 will be described. The control unit 50 extracts features of the 3D shape of the subject using the 3D data. The control unit 50 allocates each point corresponding to the 3D coordinates in the 3D data to one of two or more feature regions. The 3D shape of the subject has a common feature in one feature region. The feature of the 3D shape of the subject varies between two or more different feature regions. Only one point may be allocated to one feature region. When two or more points are allocated to one feature region, the two or more points satisfy a common condition indicating the feature of the 3D shape of the subject. The condition satisfied by points in a first feature region and the condition satisfied by points in a second feature region different from the first feature region are different from each other.

The segmentation is used as a simple method of classifying points corresponding to 3D data. For example, the control unit 50 can use Euclidean cluster extraction for the segmentation. This is a function provided in a point cloud library (PCL) which is an open source.

The control unit 50 determines a point within a predetermined distance from each point included in the 3D data as a nearby point using this function. One point and a nearby point thereof are located on the same object. For example, when the subject includes a first object and a second object that are separated from each other, the points included in the 3D data are classified into one of a point on the first object and a point on the second object. Each of the first object and the second object is a feature region (a segment). In this case, two or more points in one feature region have a feature of being located on the same object.

The control unit 50 may use a watershed algorithm, a deep learning algorithm, or the like for the segmentation. The control unit 50 may calculate a normal line perpendicular to the surface of the subject based on the 3D data and may detect an edge or a step of the subject as a feature region based on a change in the normal direction. For example, the control unit 50 may detect a first feature region including an edge or a step and a second feature region including parts other than the edge or the step.

The control unit 50 may detect an edge of the subject by executing image processing on a 2D image of the subject. The control unit 50 may detect a feature region corresponding to the edge in the 2D image from the 3D shape of the subject indicated by the 3D data. The control unit 50 may detect a feature region based on brightness or colors of the 2D image. The control unit 50 may execute a matching process on a stereoscopic image of the subject and detect a feature region based on a correlation value acquired through the matching process.

After Step S103, the control unit 50 generates a 3D image based on the 3D data and outputs the 3D image to the display 51. The display 51 displays the 3D image (Step S104). The 3D image is an image of the 3D shape of the subject.

The control unit 50 may superimpose information of one or more feature regions on the 3D image and may output the 3D image on which the information is superimposed to the display 51. For example, the control unit 50 may superimpose a graphic (computer graphics) with colors corresponding to the feature regions on the 3D image. Alternatively, the control unit 50 may superimpose a graphic indicating a frame surrounding each feature region on the 3D image.

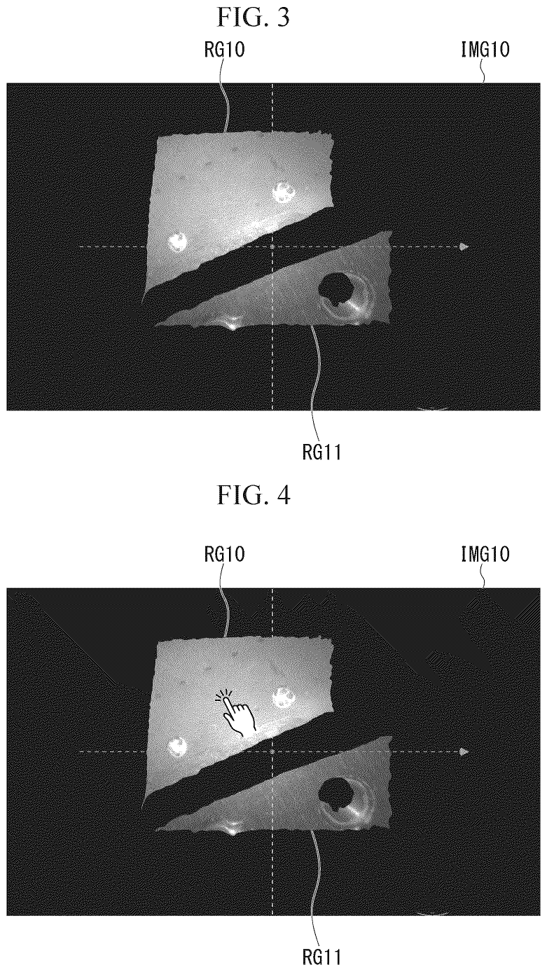

FIG. 3 shows an example of a 3D image displayed on the display 51 in Step S104. The control unit 50 displays a 3D image IMG10 shown in FIG. 3 on the display 51. The 3D image IMG10 includes a first region RG10 and a second region RG11 of the subject.

After the 3D image is displayed, a user operates the touch panel 52 or the like to select a measurement target region. By doing this, the user inputs position information indicating a position on the 3D image displayed on the display 51. The control unit 50 receives the position information and selects a feature region at the position indicated by the position information as the measurement target region. The number of feature regions selected as the measurement target region is less than or equal to the number of feature regions detected in Step S103. When only one feature region is detected in Step S103, the control unit 50 may select the feature region as the measurement target region without receiving the position information. The control unit 50 may select two or more feature regions as the measurement target region (Step S105).

FIG. 4 shows an example of a 3D image displayed on the display 51 in Step S105. The control unit 50 displays a 3D image IMG10 shown in FIG. 4 on the display 51. The 3D image IMG10 shown in FIG. 4 includes a first region RG10 and a second region RG11 similarly to the 3D image IMG10 shown in FIG. 3.

The control unit 50 detects the first region RG10 and the second region RG11 as feature regions in Step S103. For example, the user inputs position information indicating a position in the first region RG10. The control unit 50 selects the first region RG10 as the measurement target region.

After Step S105, the control unit 50 sets one or more points included in the measurement target region selected in Step S105 as a measurement point. The one or more points are included in the 3D data. For example, the control unit 50 sets a point located at the position indicated by the position information received in Step S105 as the measurement point. In the following example, the control unit 50 sets all points included in the measurement target region as the measurement points (Step S106). Information of the measurement points is stored in the volatile memory 56.

After Step S106, the control unit 50 acquires distance information of the measurement points from the volatile memory 56 (Step S107).

After Step S107, the control unit 50 sets a display state of a graphic at each of the positions corresponding to the measurement points in accordance with the 3D distance indicated by the distance information. For example, the control unit 50 sets the color of the graphic to a color corresponding to the 3D distance. The control unit 50 superimposes the graphic on the 3D image (Step S108). In the following description, the 3D distance indicated by the distance information of the measurement point is referred to as the 3D distance at the measurement point.

After Step S108, the control unit 50 outputs the 3D image on which the graphic is superimposed on the display 51. The display 51 displays the 3D image. The user may input information for instructing to display the 3D image by operating the touch panel 52 or the like. When the information is input, the control unit 50 may output the 3D image on which the graphic is superimposed to the display 51 (Step S109). When Step S109 is executed, the measurement process shown in FIG. 2 ends.

Before Step S101 or S102 is executed, at least one of Steps S103 to S106 may be executed. Before one of Steps S101 to S103 is executed, Step S104 may be executed.

Before Step S105 is executed, the control unit 50 may calculate the 3D distance between the measurement reference and each of all the points on the subject and display the 3D image on which the graphic set based on the 3D distance is superimposed on the display 51. When only one feature region is detected, the user can recognize that selection of a feature region is not necessary by checking the 3D image on which the graphic is superimposed. The user need not select a feature region and input information for instructing display of the 3D image.

In the measurement process shown in FIG. 2, the control unit 50 automatically sets the measurement reference. When the user inputs an instruction for selecting a measurement target region to the endoscope system 1, the control unit 50 automatically sets a measurement point. Therefore, it is possible to reduce the user's labor and to enhance measurement efficiency.

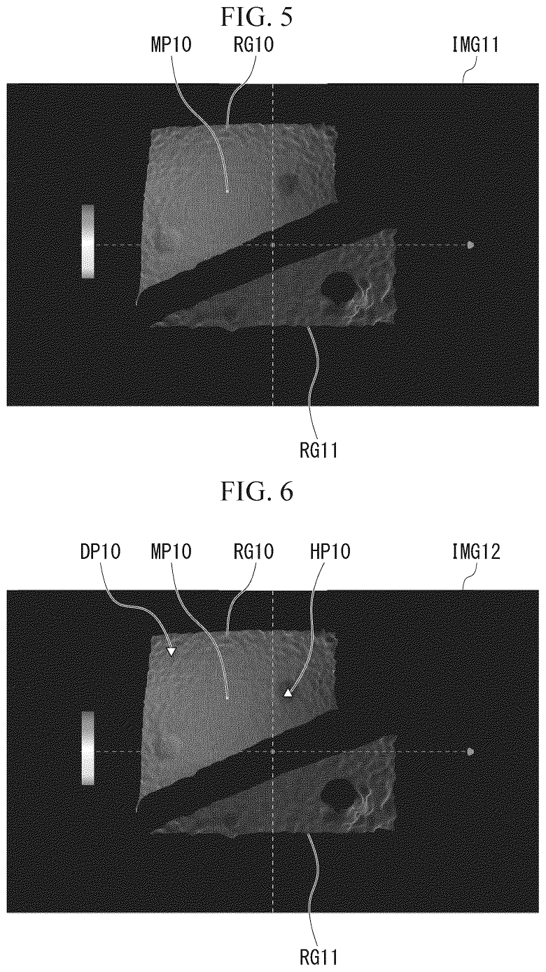

FIG. 5 shows a first example of a 3D image displayed on the display 51 in Step S109. The control unit 50 displays a 3D image IMG11 shown in FIG. 5 on the display 51. The 3D image IMG11 includes a first region RG10 and a second region RG11 similarly to the 3D image IMG10 shown in FIG. 3.

The control unit 50 superimposes a graphic indicating a measurement point MP10 located at the position indicated by the position information received in Step S105 on the 3D image IMG11. The control unit 50 superimposes a graphic with colors corresponding to the 3D distances at the measurement points in the first region RG10 selected as the measurement target region on the 3D image IMG11. That is, the control unit 50 superimposes a graphic for displaying a color map on the 3D image IMG11. The graphic indicates a measurement result of the 3D distance. The image of the first region RG10 have a color corresponding to the 3D distance between the position of the distal end of the endoscope and each of the measurement points. The control unit 50 may superimpose a graphic such as numerical values indicating the 3D distance on the 3D image IMG11.

A region of interest in the embodiments of the present invention is an abnormal region such as a recessed part, a protruding part, or a scratch. Since a color map having colors set in accordance with the 3D distances at the measurement points is displayed, the user can easily check the state of the abnormal region.

The control unit 50 superimposes a graphic for causing an image of a feature region other than the measurement target region to be inconspicuous on the 3D image IMG11. For example, an image of the second region RG11 is grayed out. The control unit 50 may set the image of the second region RG11 to be invisible. The user can intensively check an inspection result in the measurement target region which is a region of interest. The control unit 50 may display an image of the feature region set to be invisible on the display 51 again.

FIG. 6 shows a second example of the 3D image displayed on the display 51 in Step S109. The control unit 50 displays a 3D image IMG12 shown in FIG. 6 on the display 51. The 3D image IMG12 includes a first region RG10 and a second region RG11 similarly to the 3D image IMG10 shown in FIG. 3.

The control unit 50 superimposes a graphic indicating the measurement point MP10 on the 3D image IMG12 similarly to the 3D image IMG11 shown in FIG. 5. The control unit 50 superimposes a graphic for displaying a color map on the 3D image IMG12 similarly to the 3D image IMG11 shown in FIG. 5.

The control unit 50 identifies the maximum value and the minimum value of the 3D distances at the measurement points in the first region RG10. The measurement point at which the maximum value has been measured corresponds to the deepest point of a recessed part formed in a subject. The measurement point at which the minimum value has been measured corresponds to the highest point of a protruding part formed in the subject.

The control unit 50 superimposes a graphic of an icon indicating the highest point HP10 on the 3D image IMG12. The graphic is superimposed at the position of the highest point HP10. The control unit 50 superimposes a graphic of an icon indicating the deepest point DP10 on the 3D image IMG12. The graphic is superimposed at the position of the deepest point DP10. The graphic of the icon indicating the highest point HP10 or the deepest point DP10 indicates a measurement result of the 3D distance. The control unit 50 need not superimpose a graphic for displaying a color map on the 3D image IMG12 but may superimpose a graphic of the icon indicating the highest point HP10 or the deepest point DP10 on the 3D image IMG12.

The measurement reference may be a point, a line, a plane, or the like set in a 3D space in which the 3D coordinates included in the 3D data are defined. For example, the user inputs position information indicating positions of one or more reference points by operating the touch panel 52 or the like. The control unit 50 receives the position information and sets reference points at the positions indicated by the position information. The reference points are included in the 3D data.

For example, the control unit 50 sets a straight line including two reference points. In Step S102, the control unit 50 calculates the 3D distance between the straight line and each measurement point. Alternatively, the control unit 50 sets a plane including three reference points. In Step S102, the control unit 50 calculates the 3D distance between the plane and each measurement point.

After the measurement reference is set, the measurement reference may be changed. For example, after the position of the distal end of the endoscope is set as the measurement reference, the measurement reference may be changed to a point, a line, a plane, or the like. Details of the method of changing the measurement reference will be described later in a fourth embodiment.

The control unit 40 may execute the measurement process shown in FIG. 2. Alternatively, the control unit 40 and the control unit 50 may cooperatively execute the measurement process.

The measurement device according to each aspect of the present invention includes the control unit 50. The control unit 50 acquires 3D data including 3D coordinates of two or more points on a subject calculated based on an endoscopic image (a 2D image) of the subject acquired by the endoscope (the insertion unit 2). The control unit 50 sets a measurement reference indicting a reference position for measurement. The control unit 50 detects one or more feature regions on the subject based on the 3D data or the endoscopic image. A 3D shape of the subject has a common feature in each of the one or more feature regions. The control unit 50 selects at least one feature region of the one or more feature regions as a measurement target region. The control unit 50 sets one or more points included in the measurement target region and included in the two or more points as a measurement point. The control unit 50 generates distance information indicating the distance between the measurement reference and the measurement point. The control unit 50 superimposes a measurement result generated based on the distance information on an image of the measurement target region and outputs the image on which the measurement result is superimposed to the display 51. The image of the measurement target region is at least part of an image of a 3D shape generated based on the 3D data.

The control unit 50 may generate a graphic to be superimposed on the image of the measurement target region based on the measurement result generated based on the distance information. The control unit 50 may output the image of the measurement target region and the graphic. The control unit 50 may superimpose the graphic on the image of the measurement target region and may output the image on which the graphic is superimposed to a processing device, a recording medium or the like. For example, the control unit 50 may store the image of the measurement target region and the graphic as data such as CSV in a memory. The data stored in the memory may be output to another device or may be processed by software that operates in that device. For example, the software may superimpose the graphic output from the memory on the image output from the memory and display that image on the display. The software may execute various processes on the data output from the memory.

The measurement method according to each aspect of the present invention includes first to eighth steps. The control unit 50 acquires 3D data in the first step (Step S100). The control unit 50 sets a measurement reference in the second step (Step S101). The control unit 50 detects one or more feature regions on a subject in the third step (Step S103). The control unit 50 selects at least one feature region as a measurement target region in the fourth step (Step S105). The control unit 50 sets one or more points as a measurement point in the fifth step (Step S106). The control unit 50 generates distance information indicating the distance between the measurement reference and the measurement point in the sixth step (Step S107). The control unit 50 superimposes a measurement result generated based on the distance information on an image of the measurement target region based on the distance information in the seventh step (Step S108). The control unit 50 outputs the image on which the measurement result is superimposed to the display 51 in the eighth step (Step S109).

The program according to each aspect of the present invention causes a computer to execute the first to eighth steps.

Each aspect of the present invention may include the following modified example. The control unit 50 superimposes a graphic including a display state that is set based on the distance information as a measurement result on the image of the measurement target region.

Each aspect of the present invention may include the following modified example. The control unit 50 selects at least one measurement point of two or more measurement points included in the measurement target region based on the distance indicated by the distance information of each of the two or more measurement points. The control unit 50 superimposes information of the at least one measurement point as the measurement result on the image of the measurement target region.

Each aspect of the present invention may include the following modified example. The control unit 50 selects a measurement point at which the distance indicated by the distance information is the largest or the smallest as the at least one measurement point.

Each aspect of the present invention may include the following modified example. The control unit 50 sets all the points included in two or more points which are included in the measurement target region and which are included in the 3D data as measurement points.

Each aspect of the present invention may include the following modified example. The control unit 50 detects one or more feature regions based on a shape feature of the two or more points included in the 3D data.

Each aspect of the present invention may include the following modified example. The control unit 50 detects one or more feature regions based on an image feature in the endoscopic image.

Each aspect of the present invention may include the following modified example. When only one feature region on the subject is detected, the control unit 50 selects the one feature region as the measurement target region.

Each aspect of the present invention may include the following modified example. When two or more feature regions on the subject are detected, the control unit 50 selects at least one feature region of the two or more feature regions as the measurement target region.

Each aspect of the present invention may include the following modified example. The control unit 50 selects at least one feature region as the measurement target region based on information input to an input device (the touch panel 52 or the like).

Each aspect of the present invention may include the following modified example. The control unit 50 sets a point at the position of the distal end of the endoscope as the measurement reference.

In the first embodiment, the control unit 50 sets a measurement reference and selects at least one feature region as a measurement target region. The control unit 50 sets one or more points included in the measurement target region as measurement points. Since a user's operating labor is reduced, the endoscope system 1 can efficiently execute measurement.

When the control unit 50 selects part of a region of the subject as the measurement target region, the user can intensively check the measurement result in the measurement target region.

### First Modified Example of First Embodiment

A first modified example of the first embodiment of the present invention will be described. In the first modified example of the first embodiment, the control unit 50 automatically selects a feature region detected through segmentation as the measurement target region.

The endoscope system 1 executes the measurement process shown in FIG. 2. The control unit 50 executes the following process in Step S105.

When only one feature region is detected in Step S103, the control unit 50 selects the feature region as the measurement target region. When two or more feature regions are detected in Step S103, the control unit 50 selects at least one feature region of the two or more feature regions as the measurement target region.

First to fourth examples will be described below.

First, the first example will be described. The control unit 50 calculates a 3D distance between each of two or more feature regions and the position of the distal end of the endoscope and selects a feature region in which the 3D distance is the smallest as a measurement target region.

Next, the second example will be described. The control unit 50 selects a measurement target region based on a shape feature of two or more feature regions. Specifically, the control unit 50 selects a feature region with the largest size as a measurement target region. The control unit 50 may determine the size of a feature region based on the number of points included in the feature region.

Next, the third example will be described. In the third example, the control unit 50 also selects a measurement target region based on a shape feature of two or more feature regions. Specifically, the control unit 50 calculates a 3D distance between the position of the distal end of the endoscope and each point in the feature regions. The control unit 50 identifies a maximum value and a minimum value of the 3D distances. The difference between the maximum value and the minimum value indicates the degree of unevenness in a feature region. The control unit 50 selects a feature region in which the degree of unevenness is the largest as the measurement target region.

Next, the fourth example will be described. The control unit 50 selects a feature region displayed at the center of the screen of the display 51 as a measurement target region.

After a measurement target region is selected as described above, the control unit 50 may select another measurement target region in accordance with an instruction from a user.

Each aspect of the present invention may include the following modified example. The control unit 50 selects a feature region in which the distance between each of two or more feature regions and the position of the distal end of the endoscope is the smallest as a measurement target region.

Each aspect of the present invention may include the following modified example. The control unit 50 selects at least one feature region as a measurement target region based on a shape feature of two or more feature regions.

In the first modified example of the first embodiment, the endoscope system 1 can efficiently execute measurement similarly to the first embodiment.

### Second Modified Example of First Embodiment

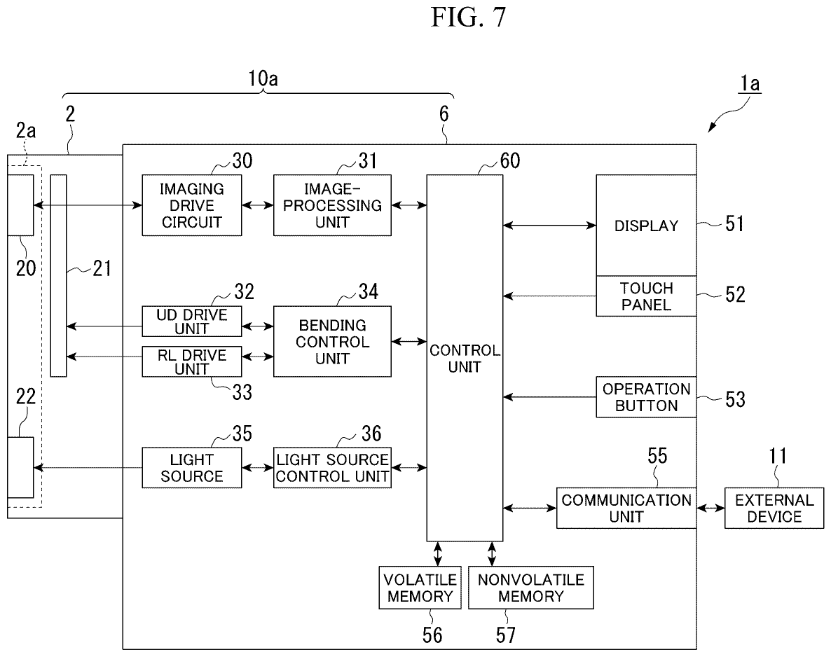

A second modified example of the first embodiment of the present invention will be described. FIG. 7 shows an example of the configuration of an endoscope system 1a according to the second modified example of the first embodiment. The same configuration as that shown in FIG. 1 will not be described.

The endoscope system 1a shown in FIG. 7 includes an insertion unit 2 and a main unit 6. The insertion unit 2 and the main unit 6 constitute an endoscope device 10a.

The insertion unit 2 shown in FIG. 7 is the same as the insertion unit 2 shown in FIG. 1. The main unit 6 includes an imaging drive circuit 30, an image-processing unit 31, a UD drive unit 32, an RL drive unit 33, a bending control unit 34, a light source 35, a light source control unit 36, a display 51, a touch panel 52, an operation button 53, a communication unit 55, a volatile memory 56, a nonvolatile memory 57, and a control unit 60. The same reference signs as those shown in FIG. 1 are assigned to the same blocks as those shown in FIG. 1.

The control unit 60 has both the function of the control unit 40 shown in FIG. 1 and the function of the control unit 50 shown in FIG. 1. The control unit 60 executes the process shown in FIG. 2.

In the second modified example of the first embodiment, the endoscope system 1 can efficiently execute measurement similarly to the first embodiment.

### Third Modified Example of First Embodiment

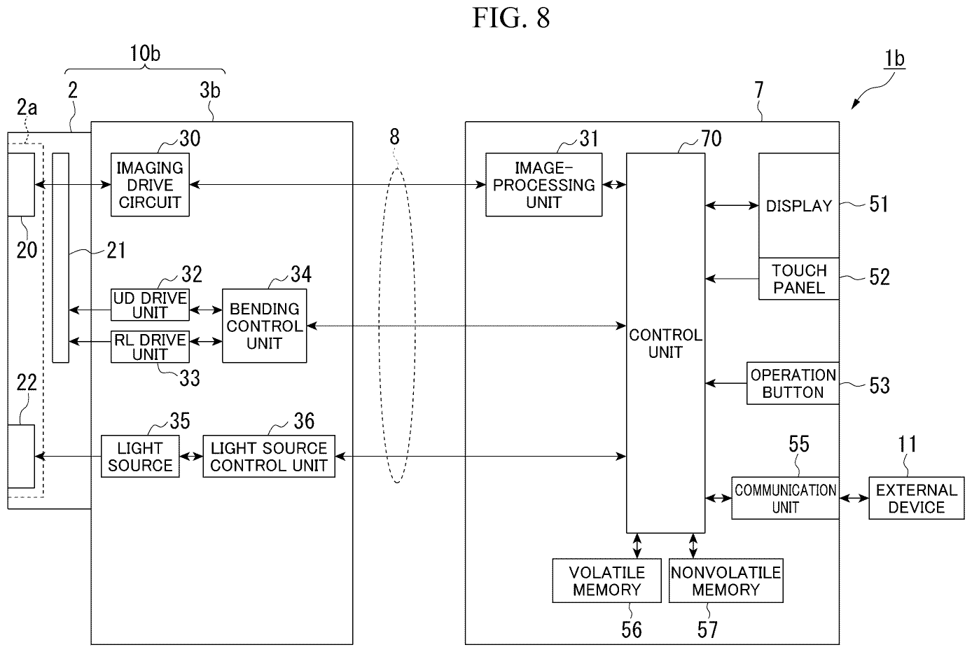

A third modified example of the first embodiment of the present invention will be described. FIG. 8 shows an example of the configuration of an endoscope system 1b according to the third modified example of the first embodiment. The same configuration as that shown in FIG. 1 will not be described.

The endoscope system 1b shown in FIG. 8 includes an insertion unit 2, a scope unit 3b, and a base unit 7. The insertion unit 2 and the scope unit 3b constitute an endoscope device 10b. The scope unit 3b and the base unit 7 are connected to a cable 8.

The insertion unit 2 shown in FIG. 8 is the same as the insertion unit 2 shown in FIG. 1. The scope unit 3b shown in FIG. 8 is the same as the scope unit 3 shown in FIG. 1 except that the image-processing unit 31 is not included. The base unit 7 includes an image-processing unit 31, a display 51, a touch panel 52, an operation button 53, a communication unit 55, a volatile memory 56, a nonvolatile memory 57, and a control unit 70. The same reference signs as those shown in FIG. 1 are assigned to the same blocks as those shown in FIG. 1.

The control unit 70 has both the function of the control unit 40 shown in FIG. 1 and the function of the control unit 50 shown in FIG. 1. The control unit 70 executes the process shown in FIG. 2.

In the third modified example of the first embodiment, the endoscope system 1 can efficiently execute measurement similarly to the first embodiment.

### Second Embodiment

A second embodiment of the present invention will be described. In the second embodiment, the endoscope system 1 shown in FIG. 1 is used. The endoscope system 1a shown in FIG. 7 or the endoscope system 1b shown in FIG. 8 may be used.

The control unit 50 detects an abnormal region in a measurement target region and changes a display state of the abnormal region in a 3D image of a subject. The abnormal region is a region including a recessed part, a protruding part, or a scratch.

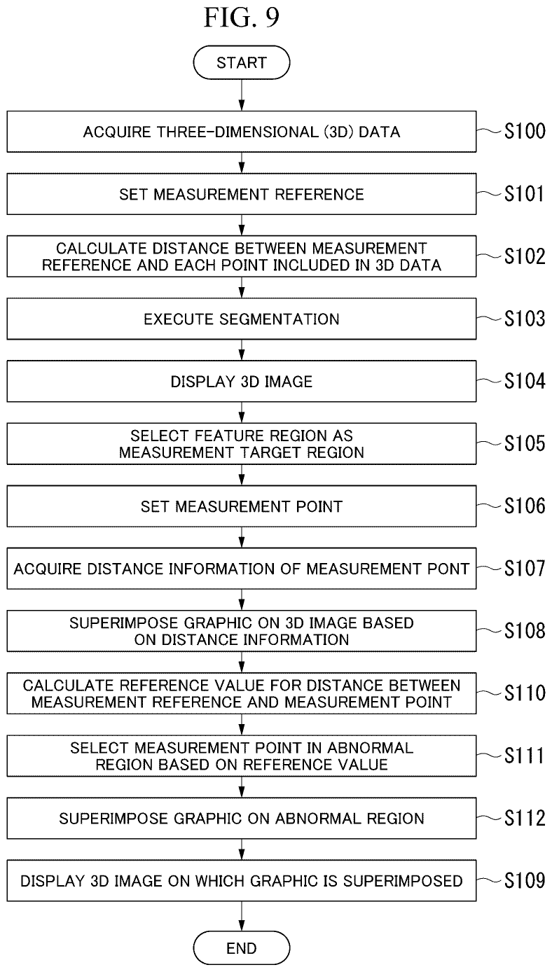

FIG. 9 shows an example of a procedure of a measurement process executed by the endoscope system 1. The operations of the endoscope system 1 will be described with reference to FIG. 9. The same process as that shown in FIG. 2 will not be described.

After Step S108, the control unit 50 calculates a reference value for 3D distances each of which is the 3D distance between the measurement reference and each measurement point in the measurement target region. For example, the control unit 50 calculates the average value of the 3D distances at the measurement points as a reference value (Step S110).

After Step S110, the control unit 50 compares the 3D distance at each measurement point with the reference value and selects one or more measurement points in the measurement target region. The one or more measurement points constitute an abnormal region. For example, the control unit 50 extracts 3D distances not included in a predetermined range centered on the reference value and selects the measurement points with the 3D distances. For example, the predetermined range is set based on the standard deviation of the 3D distances at the measurement points (Step S111).

After Step S111, the control unit 50 sets a display state of a graphic at a position corresponding to the measurement point selected in Step S111. For example, the control unit 50 sets the colors of the graphic to predetermined colors. The control unit 50 superimposes the graphic on the 3D image (Step S112). After Step S112, Step S109 is executed.

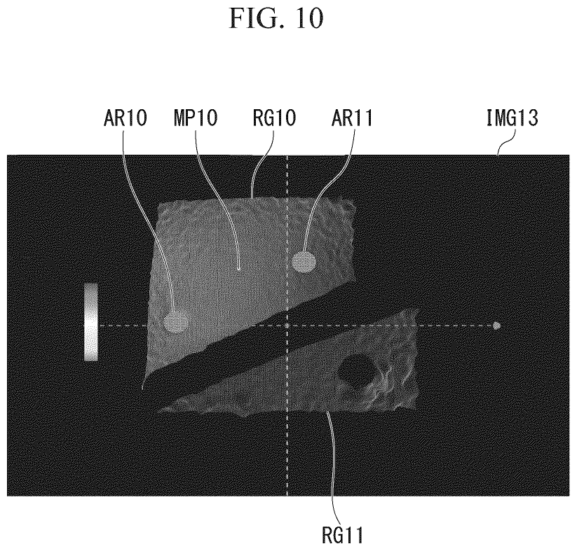

FIG. 10 shows an example of the 3D image displayed on the display 51 in Step S109. The control unit 50 displays a 3D image IMG13 shown in FIG. 10 on the display 51. The 3D image IMG13 includes a first region RG10 and a second region RG11 similarly to the 3D image IMG10 shown in FIG. 3.

The control unit 50 superimposes a graphic indicating the measurement point MP10 on the 3D image IMG13 similarly to the 3D image IMG11 shown in FIG. 5. The control unit 50 superimposes a graphic for displaying a color map on the 3D image IMG13 similarly to the 3D image IMG11 shown in FIG. 5. The control unit 50 superimposes a graphic indicating an abnormal region AR10 and a graphic indicating an abnormal region AR11 on the 3D image IMG13.

Each aspect of the present invention may include the following modified example. The control unit 50 calculates a reference value based on the 3D distance indicated by distance information at each of two or more measurement points included in the measurement target region. The control unit 50 selects at least one measurement point based on a result of comparing the 3D distance with the reference value.

In the second embodiment, the endoscope system 1 can cause an abnormal region in the 3D image displayed on the display 51 to be conspicuous and to allow a user to intensively check the state of the abnormal region.

### Third Embodiment

A third embodiment of the present invention will be described. In the third embodiment, the endoscope system 1 shown in FIG. 1 is used. The endoscope system 1a shown in FIG. 7 or the endoscope system 1b shown in FIG. 8 may be used.

Before a user inputs position information of a measurement target region, the control unit 50 detects a feature region including an abnormal region and displays information of the feature region on the display 51. The user selects the measurement target region by referring to the information displayed on the display 51.

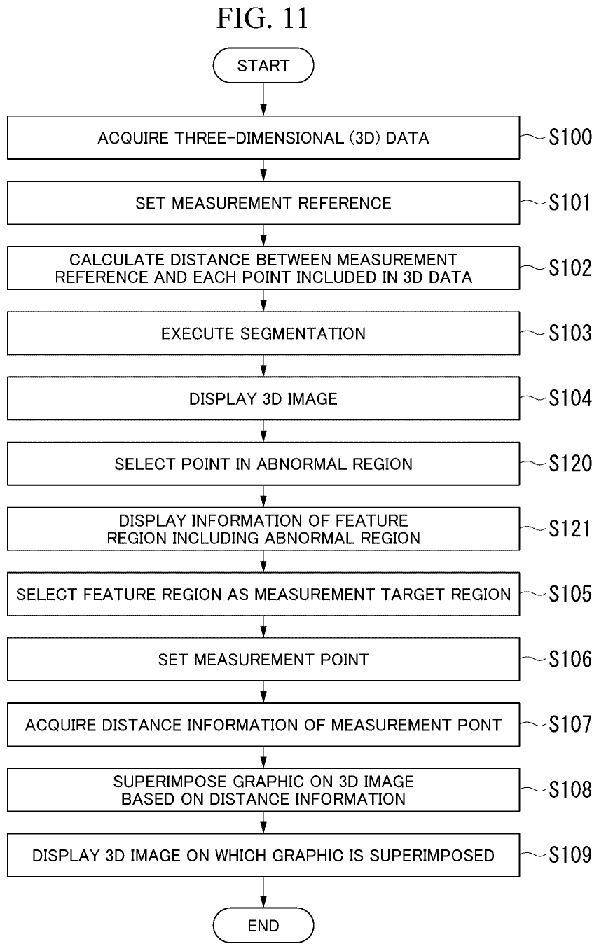

FIG. 11 shows an example of a procedure of a measurement process executed by the endoscope system 1. The operations of the endoscope system 1 will be described with reference to FIG. 11. The same process as that shown in FIG. 2 will not be described.

After Step S104, the control unit 50 compares the 3D distance at each point included in the 3D data with the reference value and selects one or more points. The one or more points constitute an abnormal region. For example, the control unit 50 extracts 3D distances not included in a predetermined range centered on the reference value and selects the points with the 3D distances. For example, the predetermined range is set based on the standard deviation of the 3D distances at the points (Step S120).

After Step S120, the control unit 50 outputs information of a feature region including an abnormal region including the one or more points selected in Step S120 to the display 51. The display 51 displays the information (Step S121). After Step S121, Step S105 is executed.

The control unit 50 may calculate the number of points included in the abnormal region for each feature region. The control unit 50 may output information of a feature region including an abnormal region including the largest number of points to the display 51.

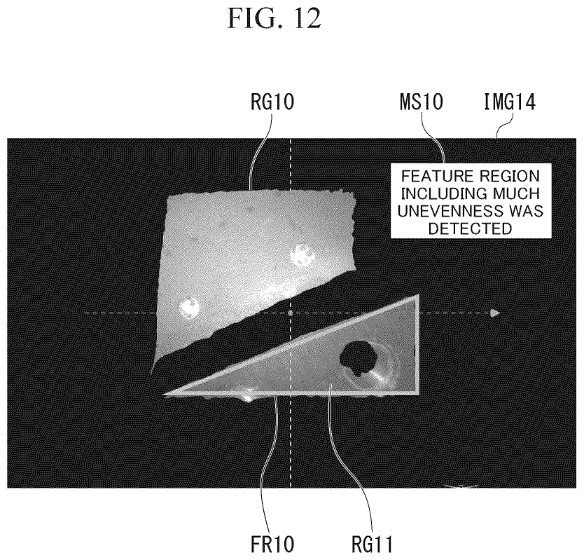

FIG. 12 shows an example of a 3D image displayed on the display 51 in Step S121. The control unit 50 displays a 3D image IMG14 shown in FIG. 12 on the display 51. The 3D image IMG14 includes a first region RG10 and a second region RG11 similarly to the 3D image IMG10 shown in FIG. 3.

When the second region RG11 includes an abnormal region, the control unit 50 superimposes a graphic of a frame FR10 surrounding the second region RG11 on the 3D image IMG14. The control unit 50 superimposes a message MS10 indicating that the feature region including an abnormal region has been detected on the 3D image IMG14. A user can determine that the second region RG11 is appropriate for measurement.

Each aspect of the present invention may include the following modified example. The control unit 50 calculates the distance between the measurement reference and each of the two or more points included in the 3D data. The control unit 50 selects at least one point of the two or more points based on the distance. The control unit 50 outputs information of a feature region which is included in one or more feature regions and which includes the selected at least one point to the display 51.

In the third embodiment, the endoscope system 1 can notify a user of information of the feature region including an abnormal region and can encourage the user to select the feature region as the measurement target region.

### Modified Example of Third Embodiment

A modified example of the third embodiment of the present invention will be described. In the modified example of the third embodiment, the control unit 50 determines whether the measurement target region includes an abnormal region after a user has input position information of the measurement target region. That is, the control unit 50 determines whether the measurement target region is appropriate for measurement. When the measurement target region is appropriate for measurement, the control unit 50 displays information indicating that reselection of the measurement target region is not necessary on the display 51. When the measurement target region is not appropriate for measurement, the control unit 50 displays information indicating that reselection of the measurement target region is necessary on the display 51.

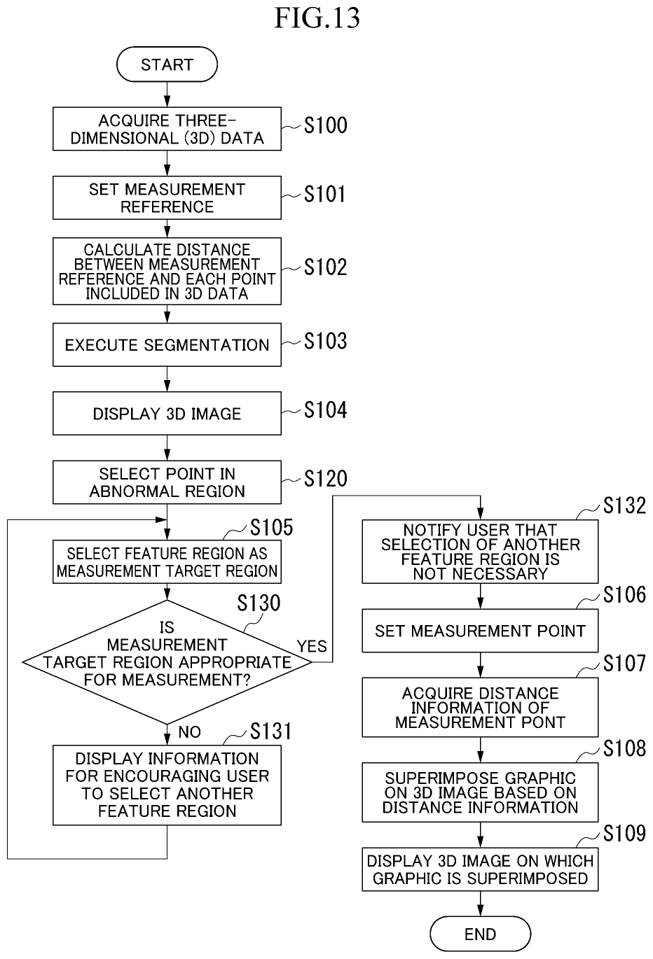

FIG. 13 shows an example of a procedure of a measurement process executed by the endoscope system 1. The operations of the endoscope system 1 will be described with reference to FIG. 13. The same process as that shown in FIG. 12 will not be described.

After Step S120, Step S105 is executed. After Step S105, the control unit 50 determines whether the measurement target region selected in Step S105 includes a point of the abnormal region selected in Step S120. By doing this, the control unit 50 determines whether the measurement target region is appropriate for measurement (Step S130).

When the measurement target region does not include a point of the abnormal region, the control unit 50 determines in Step S130 that the measurement target region is not appropriate for measurement. The control unit 50 outputs information for encouraging a user to select a feature region other than the feature region selected as the measurement target region in Step S105 to the display 51. The display 51 displays the information (Step S131). After Step S131, Step S105 is executed.

When the measurement target region includes a point of the abnormal region, the control unit 50 determines in Step S130 that the measurement target region is appropriate for measurement. The control unit 50 outputs information indicating that selection of a feature region other than the feature region selected as the measurement target region in Step S105 is not necessary to the display 51. The display 51 displays the information (Step S132). After Step S132, Step S106 is executed.

The control unit 50 may calculate the number of points included in the abnormal region for each feature region. The control unit 50 may determine whether the measurement target region includes an abnormal region including the largest number of points. When the measurement target region includes the abnormal region, the control unit 50 may determine that the measurement target region is appropriate for measurement. When the measurement target region does not include the abnormal region, the control unit 50 may determine that the measurement target region is not appropriate for measurement.

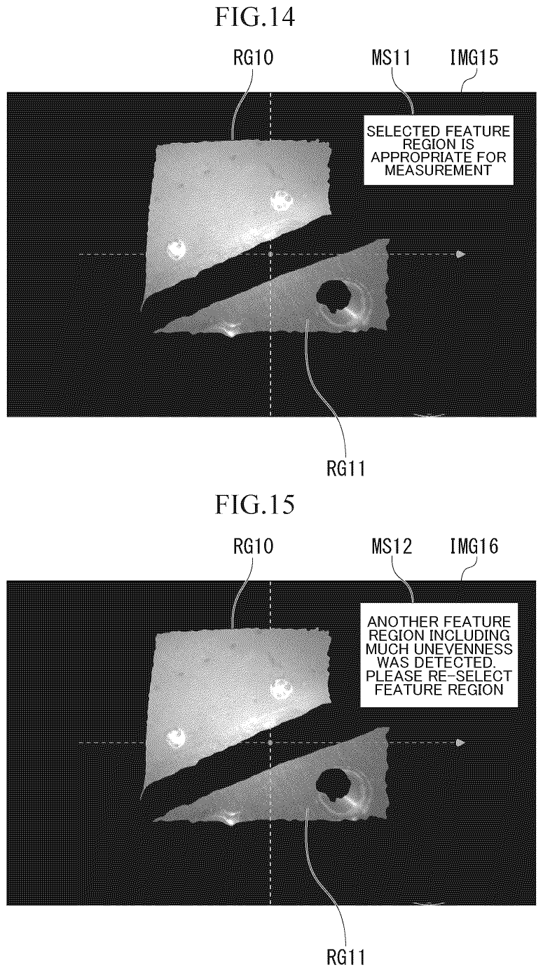

FIG. 14 shows an example of a 3D image displayed on the display 51 in Step S132. The control unit 50 displays a 3D image IMG15 shown in FIG. 14 on the display 51. The 3D image IMG15 includes a first region RG10 and a second region RG11 similarly to the 3D image IMG10 shown in FIG. 3.

The control unit 50 superimposes a message MS11 indicating that the feature region selected as the measurement target region is appropriate for measurement on the 3D image IMG15. A user can determine that reselection of a feature region is not necessary.

FIG. 15 shows a first example of a 3D image displayed on the display 51 in Step S131. The control unit 50 displays a 3D image IMG16 shown in FIG. 15 on the display 51. The 3D image IMG16 includes a first region RG10 and a second region RG11 similarly to the 3D image IMG10 shown in FIG. 3.

The control unit 50 superimposes a message MS12 indicating that the feature region selected as the measurement target region is not appropriate for measurement on the 3D image IMG16. A user can determine that reselection of a feature region is necessary.

The control unit 50 may identify the maximum value and the minimum value of the 3D distances at the two or more points included in the 3D data. The point at which the maximum value has been measured corresponds to the deepest point of a recessed part formed in a subject. The point at which the minimum value has been measured corresponds to the highest point of a protruding part formed in the subject. When the measurement target region includes the highest point or the deepest point, the control unit 50 may determine that the measurement target region is appropriate for measurement. When the measurement target region does not include any of the highest point and the deepest point, the control unit 50 may determine that the measurement target region is not appropriate for measurement.

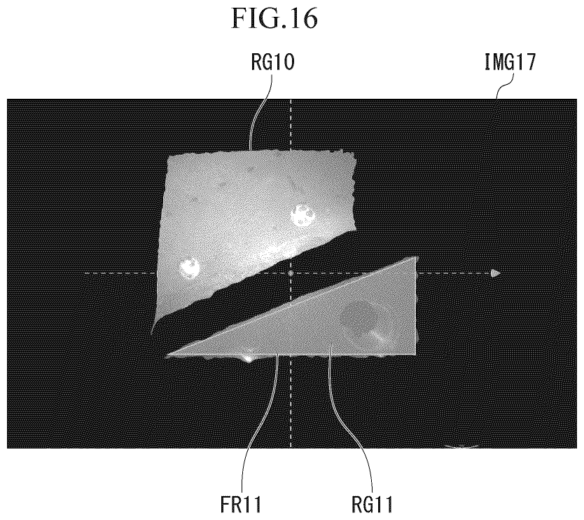

FIG. 16 shows a second example of the 3D image displayed on the display 51 in Step S131. The control unit 50 displays a 3D image IMG17 shown in FIG. 16 on the display 51. The 3D image IMG17 includes a first region RG10 and a second region RG11 similarly to the 3D image IMG10 shown in FIG. 3.

For example, the user selects the first region RG10 as the measurement target region. When the first region RG10 does not include any of the highest point and the deepest point and the second region RG11 includes the highest point or the deepest point, the control unit 50 superimposes a graphic of a frame FR11 surrounding the second region RG11 on the 3D image IMG17. The frame FR11 is displayed in a predetermined color. The user can determine that the second region RG11 is appropriate for measurement.

In the modified example of the third embodiment, the endoscope system 1 can notify a user whether the measurement target region selected by the user is appropriate for measurement. When the measurement target region selected by the user is not appropriate for measurement, the endoscope system 1 can encourage the user to reselect the measurement target region.

### Fourth Embodiment

A fourth embodiment of the present invention will be described. In the fourth embodiment, the endoscope system 1 shown in FIG. 1 is used. The endoscope system 1a shown in FIG. 7 or the endoscope system 1b shown in FIG. 8 may be used.

After the 3D image on which the measurement result is superimposed is displayed on the display 51, a user can change the measurement reference. After the measurement reference is changed, the control unit 50 calculates the 3D distance between the measurement reference and each measurement point included in the measurement target region and superimposes a graphic, set based on the 3D distance, on the 3D image.

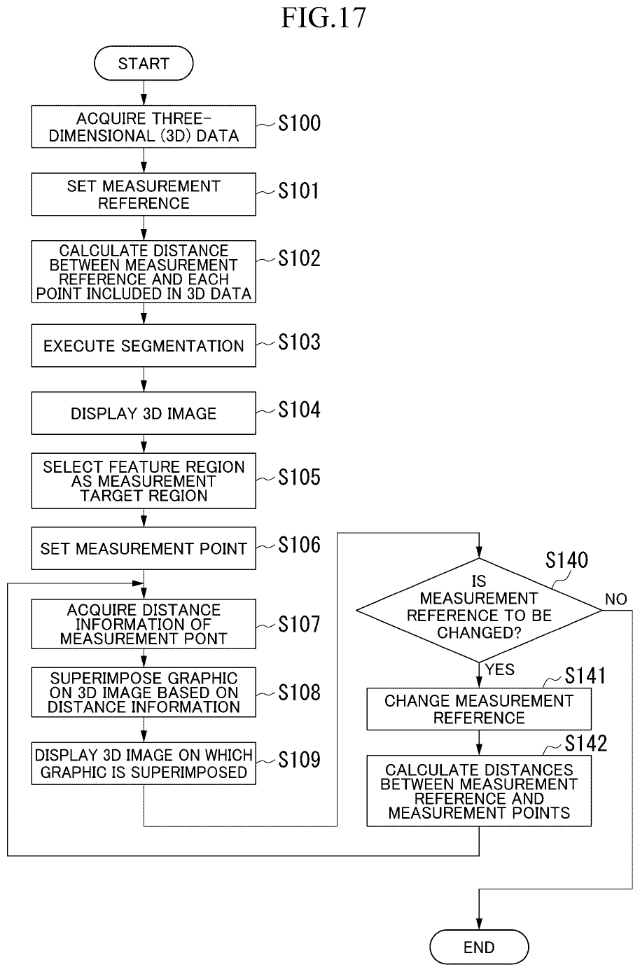

FIG. 17 shows an example of a procedure of a measurement process executed by the endoscope system 1. The operations of the endoscope system 1 will be described with reference to FIG. 17. The same process as that shown in FIG. 2 will not be described.

After Step S109, the control unit 50 outputs a message or the like for allowing a user to check whether the measurement reference is to be changed to the display 51. The user inputs information indicating whether the measurement reference is to be changed by operating the touch panel 52 or the like. The control unit 50 determines whether the measurement reference is to be changed based on the information (Step S140).

When the control unit 50 determines in Step S140 that the measurement reference is not to be changed, the measurement process shown in FIG. 17 ends. When the control unit 50 determines in Step S140 that the measurement reference is to be changed, the control unit 50 changes the measurement reference. At this time, the control unit 50 sets a measurement reference other than the measurement reference set in Step S101 (Step S141).

For example, the measurement reference indicating the position of the distal end of the endoscope is set in Step S101, and a measurement reference indicating a point, a line, a plane, or the like is set in Step S141. The user may input information indicating the measurement reference by operating the touch panel 52 or the like. The control unit 50 may change the measurement reference to the measurement reference indicated by the information.

After Step S141, the control unit 50 calculates the 3D distance between the measurement reference set in Step S141 and each measurement point set in Step S106 and generates distance information indicating the calculated 3D distance (Step S142). The distance information is stored in the volatile memory 56. After Step S142, Step S107 is executed.

The user may input position information indicating a position of one or more reference points by operating the touch panel 52 or the like to change the measurement reference. The control unit 50 may set the reference point to the position indicated by the position information. The reference point is included in the two or more points included in the 3D data.

When the user inputs position information indicating a position of one reference point, the control unit 50 sets the reference point as the measurement reference. When the user inputs position information indicating positions of two reference points, the control unit 50 sets a straight line including the two reference points as the measurement reference. When the user inputs position information indicating positions of three reference points, the control unit 50 sets a plane including the three reference points as the measurement reference.

When the user inputs position information indicating positions of two or more reference points, the control unit 50 may determine whether the two or more reference points are included in the same feature region. When the two or more reference points are included in the same feature region, the control unit 50 may change the measurement reference. When the two or more reference points are not included in the same feature region, the control unit 50 may display information for encouraging the user to reset the reference point on the display 51.

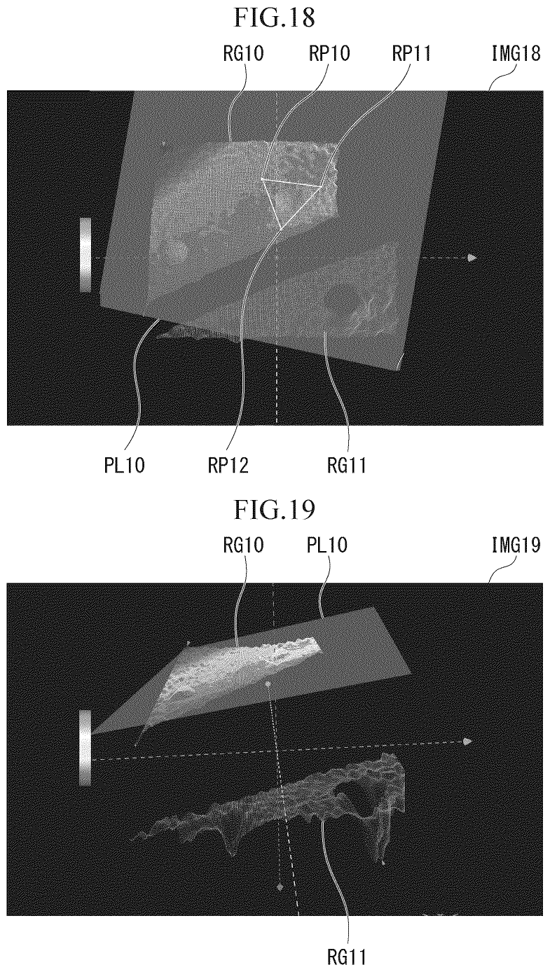

FIG. 18 shows an example of a 3D image displayed on the display 51 in Step S109 after the measurement reference is changed. The control unit 50 displays a 3D image IMG18 shown in FIG. 18 on the display 51. The 3D image IMG18 includes a first region RG10 and a second region RG11 similarly to the 3D image IMG10 shown in FIG. 3.

For example, the user inputs position information indicating positions of three reference points to change the measurement reference. The control unit 50 superimposes a graphic indicating reference points RP10, RP11, and RP12 indicated by the position information on the 3D image IMG18. The control unit 50 superimposes a graphic indicating a plane PL10 including the reference points RP10, RP11, and RP12 on the 3D image IMG18. The plane PL10 is a measurement reference.

The control unit 50 superimposes a graphic with a color corresponding to the 3D distance at each measurement point of the first region RG10 selected as the measurement target region on the 3D image IMG18. That is, the control unit 50 superimposes a graphic for displaying a color map on the 3D image IMG18.

FIG. 19 shows an example of a 3D image displayed on the display 51 after the viewpoint for displaying the 3D image IMG18 shown in FIG. 18 is changed. The control unit 50 displays a 3D image IMG19 shown in FIG. 19 on the display 51. The 3D image IMG19 includes a first region RG10 and a second region RG11 similarly to the 3D image IMG18 shown in FIG. 18. The 3D image IMG19 includes a plane PL10 similarly to the 3D image IMG18 shown in FIG. 18. A user can check a result of measurement in which a measurement reference different from the firstly set measurement reference is used. Minute unevenness on the surface of the subject may appear in the 3D image when the measurement reference other than the position of the distal end of the endoscope is used.

The control unit 50 may set two different measurement references. The control unit 50 may generate first distance information in Step S107 using a first measurement reference, may superimpose a first graphic on the 3D image based on the first distance information in Step S108, and may display the 3D image on which the first graphic is superimposed on the display 51 in Step S109.

The control unit 50 may generate second distance information in Step S107 using a second measurement reference other than the first measurement reference, may superimpose a second graphic on a 3D image based on the second distance information in Step S108, and may display the 3D image on which the second graphic is superimposed on the display 51 in Step S109.

The control unit 50 may display one of the 3D image on which the first graphic is superimposed and the 3D image on which the second graphic is superimposed on the display 51. The control unit 50 may switch between a first state and a second state. In the first state, the display 51 displays the 3D image on which the first graphic is superimposed. In the second state, the display 51 displays the 3D image on which the second graphic is superimposed.

In the present aspect using the first graphic and the second graphic, the order in which a method or a process of setting a region is executed is not particularly limited. For example, the control unit 50 may set a measurement target region, may set the second measurement reference in the measurement target region, and may generate the second distance information. Alternatively, the control unit 50 may set the second measurement reference at an arbitrary position, may set a region associated with the set position as the measurement target region, and may generate the second distance information.

Each aspect of the present invention may include the following modified example. The control unit 50 sets a point at the position of the distal end of the endoscope as the first measurement reference. The control unit 50 sets the second measurement reference including one or more points of the two or more points included in the 3D data. The control unit 50 generates first distance information indicating the distance between the first measurement reference and a measurement point and generates second distance information indicating the distance between the second measurement reference and a measurement point. The control unit 50 superimposes a first measurement result generated based on the first distance information on an image of the measurement target region and superimposes a second measurement result generated based on the second distance information on the image of the measurement target region. The control unit 50 outputs the image on which the first measurement result is superimposed and the image on which the second measurement result is superimposed to the display.

Each aspect of the present invention may include the following modified example. The control unit 50 outputs one of the image on which the first measurement result is superimposed and the image on which the second measurement result is superimposed to the display 51. Displaying the image on which the first measurement result is superimposed and displaying the image on which the second measurement result is superimposed is switchable.

In the fourth embodiment, the control unit 50 executes measurement using two or more measurement references. The endoscope system 1 can notify a user of the measurement results acquired using the two or more measurement references.

While preferred embodiments of the invention have been described and shown above, it should be understood that these are examples of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. A measurement device comprising a processor configured to execute:
acquiring three-dimensional data including three-dimensional coordinates of two or more points on a subject which are calculated based on an endoscopic image of the subject acquired by an endoscope;
setting a measurement reference indicating a reference position for measurement;
detecting one or more feature regions on the subject based on the three-dimensional data or the endoscopic image, wherein a three-dimensional shape of the subject has a common feature in each of the one or more feature regions;
selecting at least one feature region of the one or more feature regions as a measurement target region;
setting one or more points included in the measurement target region and included in the two or more points as a measurement point;
generating distance information indicating a distance between the measurement reference and the measurement point;
superimposing a measurement result generated based on the distance information on an image of the measurement target region; and
outputting the image on which the measurement result is superimposed to a display.

2. The measurement device according to claim 1, wherein the processor is configured to superimpose a graphic having a display state that is set based on the distance information as the measurement result on the image of the measurement target region.

3. The measurement device according to claim 1, wherein the processor is configured to:
select at least one measurement point of two or more measurement points based on a distance indicated by the distance information of each of the two or more measurement points included in the measurement target region; and
superimpose information on the at least one measurement point as the measurement result on the image of the measurement target region.

4. The measurement device according to claim 3, wherein the processor is configured to select a measurement point for which the distance is largest or smallest as the at least one measurement point.

5. The measurement device according to claim 3, wherein the processor is configured to:
calculate a reference value based on the distance; and
select the at least one measurement point based on a result of comparing the distance with the reference value.

6. The measurement device according to claim 1, wherein the processor is configured to set all points included in the measurement target region and included in the two or more points as the measurement point.

7. The measurement device according to claim 1, wherein the processor is configured to detect the one or more feature regions based on a shape feature of the two or more points included in the three-dimensional data.

8. The measurement device according to claim 1, wherein the processor is configured to detect the one or more feature regions based on an image feature of the endoscopic image.

9. The measurement device according to claim 1, wherein, when only one feature region on the subject is detected, the processor is configured to select the one feature region as the measurement target region.

10. The measurement device according to claim 1, wherein, when two or more feature regions on the subject are detected, the processor is configured to select at least one feature region of the two or more feature regions as the measurement target region.

11. The measurement device according to claim 10, wherein the processor is configured to select a feature region in which a distance between each of the two or more feature regions and a position of a distal end of the endoscope is smallest as the measurement target region.

12. The measurement device according to claim 10, wherein the processor is configured to select the at least one feature region as the measurement target region based on a shape feature of the two or more feature regions.

13. The measurement device according to claim 10, wherein the processor is configured to select the at least one feature region as the measurement target region based on information input to an input device.

14. The measurement device according to claim 1, wherein the processor is configured to set a point at a position of a distal end of the endoscope as the measurement reference.

15. The measurement device according to claim 1, wherein the processor is configured to:
set a point at a position of a distal end of the endoscope as a first measurement reference;
set a second measurement reference including one or more points of the two or more points;
generate first distance information indicating a distance between the first measurement reference and the measurement point;
generate second distance information indicating a distance between the second measurement reference and the measurement point;
superimpose a first measurement result generated based on the first distance information on the image of the measurement target region;
superimpose a second measurement result generated based on the second distance information on the image of the measurement target region; and
output the image on which the first measurement result is superimposed and the image on which the second measurement result is superimposed to the display.

16. The measurement device according to claim 15,
wherein the processor is configured to output one of the image on which the first measurement result is superimposed and the image on which the second measurement result is superimposed to the display, and
wherein displaying the image on which the first measurement result is superimposed and displaying the image on which the second measurement result is superimposed are switchable.

17. The measurement device according to claim 1, wherein the processor is configured to:
calculate a distance between the measurement reference and each of the two or more points;
select at least one point of the two or more points based on the distance between the measurement reference and each of the two or more points; and
output information of a feature region which is included in the one or more feature regions and which includes the at least one point to the display.

18. A measurement method comprising:
acquiring three-dimensional data including three-dimensional coordinates of two or more points on a subject which are calculated based on an endoscopic image of the subject acquired by an endoscope;
setting a measurement reference indicating a reference position for measurement;
detecting one or more feature regions on the subject based on the three-dimensional data or the endoscopic image, wherein a three-dimensional shape of the subject has a common feature in each of the one or more feature regions;
selecting at least one feature region of the one or more feature regions as a measurement target region;
setting one or more points included in the measurement target region and included in the two or more points as a measurement point;
generating distance information indicating a distance between the measurement reference and the measurement point;
superimposing a measurement result generated based on the distance information on an image of the measurement target region; and
outputting the image on which the measurement result is superimposed to a display.

19. A non-transitory computer-readable recording medium storing a program causing a computer to execute:
acquiring three-dimensional data including three-dimensional coordinates of two or more points on a subject which are calculated based on an endoscopic image of the subject acquired by an endoscope;
setting a measurement reference indicating a reference position for measurement;
detecting one or more feature regions on the subject based on the three-dimensional data or the endoscopic image, wherein a three-dimensional shape of the subject has a common feature in each of the one or more feature regions;
selecting at least one feature region of the one or more feature regions as a measurement target region;
setting one or more points included in the measurement target region and included in the two or more points as a measurement point;
generating distance information indicating a distance between the measurement reference and the measurement point;
generating a graphic superimposed on an image of the measurement target region based on a measurement result generated based on the distance information; and
outputting the image of the measurement target region and the graphic.
